(19) United States
(12) Patent Application Publication
(10) Pub. No.: US 2025/0376570 A1
(43) Pub. Date: Dec. 11, 2025

(54) METHOD FOR PROCESSING COMPOSITE MATERIAL WASTE, DEVICE FOR IMPLEMENTING THE METHOD AND RECYCLED FIBER OBTAINED THEREBY

(71) Applicant: ALPHA RECYCLAGE COMPOSITES, Toulouse (FR)

(72) Inventors: Laura PECH, TOULOUSE (FR); Fabien TESSERAUD, TOULOUSE (FR); Ludovic MOULIN, TOULOUSE (FR)

(21) Appl. No.: 18/878,629

(22) PCT Filed: Jun. 21, 2023
(86) PCT No.: PCT/FR2023/050934

§ 371 Date: Dec. 23, 2024

(30) Foreign Application Priority Data
Jun. 24, 2022 (FR) 2206299

(51) Int. Cl. C08J 11/14; C08J 11/16

(52) U.S. Cl. CPC C08J 11/14; C08J 11/16; C08J 2300/12

(57) ABSTRACT

A method for processing a composite material comprising reinforcing fibres and an organic compound includes a post-processing step of oxidising the composite material. A reactor (100) is heated to a first temperature of between 300° C. and 600° C.; and oxygen is injected into the reactor, to produce an oxygen content of between 2% and 15% of a reaction volume of the reactor. Steam is injected into the reactor, the steam being superheated to a temperature of between 300° C. and 600° C. This oxidizes the organic compound into CO and/or CO₂. Also disclosed is a processing device configured to implement the method and a recycled fiber obtained by the method.

The present invention relates to a method for processing composite material waste.

In particular, it relates to a method for processing a composite material with fibre reinforcement, such as, for example, primarily carbon fibres, or glass fibres, or basalt fibres or others (manufacturing waste, end-of-life elements originating from the aeronautical, automotive, nautical industries, etc.), i.e. a material including fibres at least partially coated with an organic compound.

It also relates to a processing device configured to implement the method.

Finally, it relates to a recycled fibre obtained by the method.

A composite material as considered herein typically includes fibres and a matrix (i.e. an organic compound, for example an organic resin of a polymer material) in which the fibres are coated.

To recycle such a material, one possibility consists in separating the matrix and the fibres, i.e. removing the fibres from the matrix which might surround them, and thus at least recovering the constituent material of the fibres (carbon, glass, basalt or other for example), with as minimum impurities as possible.

For this purpose, a composite material could undergo a thermolysis or steam-thermolysis process.

A steam-thermolysis process, for example, allows decomposing the organic matrix of composite materials by thermal cracking in the presence of superheated steam and in the absence of oxygen. This process allows having a more complete decomposition of the polymer making up the matrix compared to a conventional pyrolysis process, thanks to a more oxidising medium while reducing damage to the fibres thanks to less severe operating conditions (for example, the temperature may be lower, or the stay time shorter). A thermolysis reactor then operates, for example, in an atmosphere under a very slight depression.

For example, the fibres obtained after steam-thermolysis (also denoted as “rCF” standing for “Recovered Carbon Fibres” in the case of carbon fibres) could be used afterwards for the production of products, then designated as “semi-finished products” (chopped fibres, short fibres, non-woven fibres, spun yarn of discontinuous fibres, yarns, etc.), because these products could then subsequently be used as a raw material to produce a composite material based on recycled material. Thus, these semi-finished products are for example intended for the manufacture, by third-party manufacturers, of new composite materials, for example for the automotive, nautical construction, or aeronautical construction or energy industries.

However, the resin might be difficult to eliminate by a simple thermolysis or steam-thermolysis step.

Consequently, undesirable organic compounds may remain present on a fibre.

Thus, the present invention aims to provide a method for processing composite materials improving the elimination of organic compound on reinforcing fibres.

To this end, according to a first aspect of the invention, a method for processing a composite material including reinforcing fibres and an organic compound at least partially coating one of the fibres is provided, the method including a step of post-processing oxidising the composite material, in a reactor, the oxidising post-processing step including:
a step of heating the reactor at a first temperature comprised between 300° C. and 600° C.;
a step of injecting oxygen (O₂) into the reactor configured to produce an oxygen content comprised between 2% and 15% of a reaction volume of the reactor,
a step of injecting steam into the reactor; this steam being superheated at a temperature comprised between 300° C. and 600° C., for example at the first temperature, and
a step of oxidising the organic compound into carbon monoxide (CO) and/or carbon dioxide (CO₂).

Hence, the oxidising post-processing herein designates a step of oxidising the material which is implemented after a thermolysis (or steam-thermolysis) type processing, in a reactor.

The method then includes an additional processing step: the oxidising post-processing step, which could therefore be implemented in addition to the thermolysis or steam-thermolysis step in order to eliminate the organic compound. An oxidising post-processing step herein consists in injecting a controlled amount of oxygen into a reactor which is maintained at a defined and controlled temperature.

In the context of processing of composite materials considered herein, this oxidising post-processing step is configured to oxidise organic compounds still present on a fibre in order to transform them into carbon monoxide (CO) and/or into carbon dioxide (CO₂).

Thus, such a step allows removing a portion of the organic compound that is not degraded, or not degradable, or not entirely degradable, by thermolysis or steam-thermolysis, irrespective of the operating conditions, as well as, where appropriate, other organic compounds (like tars, chars or other residues) which might have been obtained by transformation of the organic compound of the composite material during the prior thermolysis or steam-thermolysis step.

In particular, a step of injecting steam into the reactor during the oxidising post-processing step has the advantage of allowing stabilising the oxidising post-processing reaction, for example by stabilising the temperature of the reactor.

For example, it also allows limiting a risk of a fire outbreak; without steam, combustion problems might occur.

In an example of implementation, the step of injecting oxygen into the reactor may include an injection of pure oxygen, or any gas containing oxygen, like for example ambient air, or a nitrogen-dioxygen complex.

In an example of implementation, the reactor in which the oxidising post-processing step is implemented is the same reactor as that one in which the thermolysis or the steam-thermolysis is carried out. Yet, it could nonetheless consist of another reactor, which would then be downstream of that one intended for thermolysis or steam-thermolysis.

In an example of implementation, the oxygen is injected into the reactor at an ambient temperature, for example which is comprised between 15° C. and 50° C.

In another example of implementation, the oxygen is injected into the reactor after being heated, for example at a temperature comprised between 50° C. and 600° C., for example between 300° C. and 600° C., for example at the first temperature.

In an example of implementation, the oxygen is injected into the reactor for a time period comprised between 10 minutes and 6 hours.

For example, the oxygen is injected into the reactor at a flow rate configured to reach and then maintain a dioxygen (O₂) content of 2% to 15% in the reactor.

Hence, the flow rate could be very variable, for example comprised between 10 and 1,000 m³/h.

In an example of implementation, the oxidising post-processing step includes:
a step of reducing temperature in the reactor from the first temperature down to a second temperature, the second temperature being comprised between 300° C. and 500° C. (depending on the organic compound);
a step of maintaining the second temperature in the reactor for a time period comprised between 10 min and 6 hours; and
a step of introducing oxygen (O₂) into the reactor.

In an example of implementation, the oxidising post-processing step may further include a step of reducing steam injection into the reactor.

When the injection of steam is reduced, the steam injection flow rate is lower, and depends, for example, on a size of the reactor (for example its inner volume, and/or an amount of material to be processed present in the reactor).

In an example of implementation, the injection of steam may be stopped (namely a flow rate of 0 m³/hour).

In practice, the temperature in the reactor might often fluctuate because an oxidizing post-processing reaction might be exothermic.

Nonetheless, the oxidising post-processing may be done, at least in part, after the temperature reduction step, or during the temperature reduction step.

In an example of implementation, the oxidising post-processing step may further include at least one step of simultaneous or alternative assaying the steam and dioxygen (O₂) flow rates to maintain the temperature and the dioxygen (O₂) content of the reaction medium, respectively between 300° C. and 600° C. and 2% to 15%.

In an example of implementation, the step of reducing the temperature, from the first temperature down to the second temperature, includes a step of reducing the temperature of the superheated steam injected into the reactor.

In an example of implementation, the method includes a step of measuring an amount of oxygen at the outlet of the reactor.

In an example of implementation, the step of introducing oxygen into the reactor includes a step of regulating the injection flow rate according to an oxygen content at the outlet of the reactor.

For example, if an oxygen content is stable, the method includes:
a step of stopping oxygen injection; and/or
a step of stopping heating the steam; and/or
a step of cooling the reactor including a saturated steam injection step.

By “stable”, it should be understood a variation in the oxygen content lower than 20%, or lower than 10%, for a time period of at least 10 minutes, for example for 10 to 30 minutes.

If the oxygen content is stable, then the oxidation is complete. Consequently, the injection of oxygen could be stopped, and/or the reactor could be cooled.

A saturated steam herein designates steam at its liquid-vapour equilibrium point (it therefore consists of non-superheated steam).

In the context of the present description, it is injected at a temperature comprised between 100° C. and 170° C.

The method then includes afterwards, for example, a step of emptying the reactor.

Then, the method could be reiterated on a new load in the reactor.

In an example of implementation, the method includes, prior to the oxidising post-processing step, a step of thermolysis or steam-thermolysis, in a reactor, of a composite material including fibres and an organic matrix.

For example, the thermolysis or steam-thermolysis step is configured to produce the recycled fibres and decompose the organic matrix into at least one organic compound.

The reactor may be the same as that one in which the oxidising post-processing step is implemented, or another reactor, upstream of that one used for the oxidising post-processing step.

According to a second aspect of the invention, a processing device configured to implement a method for processing a composite material as described before is also provided.

In one embodiment, the device includes at least one reactor.

For example, the reactor is configured to implement both a steam-thermolysis step and an oxidising post-processing step.

For example, the reactor includes a supply inlet configured to supply, in the reactor, a composite material to be processed, and moreover an outlet through which so-called “recycled” fibres are recovered.

In one embodiment, the device includes a steam superheater.

For example, the steam superheater is configured to inject superheated steam into the reactor.

For example, the steam superheater is upstream of the reactor.

For example, the steam superheater is configured to set a steam up to a temperature comprised between 300° C. and 600° C. to be injected into the reactor.

In one embodiment, the device includes at least one sensor configured to control the oxidising post-processing step.

For example, the at least one sensor includes, for example, at least one temperature sensor and/or an oxygen content sensor. It may possibly include a pressure sensor.

In one embodiment, the device includes a control unit configured to automatically regulate the oxidising post-processing step, in particular according to data transmitted by the at least one sensor.

For example, it consists of an automated system for controlling the parameters of the oxidising post-processing step and of all of the associated operating modes.

In one embodiment, the device includes a water processing unit configured to process running water and provide osmosed water.

In one embodiment, the device includes a storage unit configured to store osmosed water, and for example also configured to supply, with osmosed water, a thermal oxidiser and/or a steam generator.

In one embodiment, the device includes a steam generator configured to superheat the osmosed water and provide a saturated steam for the steam superheater.

In one embodiment, the device includes a thermal oxidiser configured to process steams and gaseous products originating from the reactor.

In one embodiment, the device a primary exchanger configured to circulate osmosed water in the thermal oxidiser.

For example, the primary exchanger is a plate exchanger.

In one embodiment, the device includes a secondary exchanger configured to circulate a, air cooler, for example a glycolated water.

For example, the secondary exchanger is connected to the primary exchanger.

According to a third aspect of the invention, a recycled fibre obtained by a method for processing a composite material as described before is also provided.

In particular, such a recycled fibre includes a fibre, for example carbon, or glass, or basalt fibre or other, and between 0% by weight and 5% by weight, or between 0% by weight and 1% by weight, of organic compound residue.

A percentage denoted “% by weight” herein designates a mass percentage.

In a particular example, the recycled fibre is free of organic compound residue (which then corresponds to a content of 0% by weight).

The invention, according to one embodiment, will be well understood and its advantages will appear better upon reading the following detailed description, given for indicative and in no way limiting purposes, with reference to the appended drawing wherein:

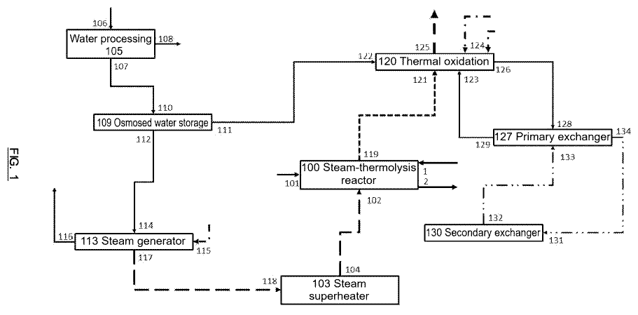

FIG. 1 schematically shows a processing method according to an implementation of the invention, in a device according to an embodiment of the invention.

The ranges of values are indicated for illustration, for a pilot installation; they should be adapted, mainly according to the capacity of the used reactor.

The following description relates to a method for processing a composite material including carbon fibres (but it could consist of any other type of fibres, for example glass fibres, or basalt fibres, or other) and an organic compound at least partially coating one of the fibres, which includes a step of post-processing oxidising the material, implemented following a step of steam-thermolysis of a composite material including fibres and an organic matrix. Nonetheless, this could be a simple thermolysis step. It also relates to the device configured to implement the method. For example, the thermolysis or steam-thermolysis step is configured to produce the fibres and decompose the organic matrix into at least one organic compound.

A steam-thermolysis allows decomposing the organic matrix of composite materials by thermal cracking in the presence of superheated steam and in the absence of oxygen. This process allows having a more complete decomposition of the polymer compared to a conventional pyrolysis process, thanks to a more oxidising medium while reducing damage of the fibres thanks to less severe operating conditions (for example, the temperature may be lower, or the stay time shorter). In general, a thermolysis reactor operates with an atmosphere under a very slight depression.

In the example of the present description, the considered composite materials used at the inlet of the method include a thermosetting (for example of epoxy or polyester or vinylester type or others) or thermoplastic (for example of the polyamide or polypropylene or polyetheretherketone or polyphenylene sulphide type or others) organic compound primarily consisting of polymerised resin, prepregs or sized dry fibres. The content of fibres in the tested laminated or pre-impregnated composite materials is in the range of 20-70% and up to 80%. In the case of dry fibres, this fibre content can rise up to 99%.

As illustrated in FIG. 1, a device configured to implement a method as described later on mainly includes a reactor 100.

In the present embodiment, the reactor 100 is configured to implement both a steam-thermolysis (or thermolysis) step and an oxidising post-processing step.

Nonetheless, in another example of implementation, a device as described herein could include two distinct reactors, one for implementing a thermolysis or steam-thermolysis step, the other one for implementing an oxidising post-processing step.

For example, the table hereinbelow presents characteristics of a reactor suitable in the context of the present invention:

TABLE
Characteristics of a steam-thermolysis reactor

| Parameters | Value | |
|---|---|---|
| Maximum composite | 1,600 | kg |
| mass/batch | | |
| Estimated volume | 3-4 m³ (smallest | |
| | dimension > 1.5 m) | |
| Temperature | 300-600° | C. |
| Service pressure | −20-−200 | Pa |
| Heating electric power | 100-150 | kW |
| Heating rate | About 4° C./min | |
| Plateau duration | 1-8 | hours |
| Cooling | Saturated | |
| | steam/nitrogen/air | |
| Maximum extraction | 5,000-7,000 | m³/h max |
| flow rate | | |
| Outlet pressure | 100-2,000 | Pa |

Consequently, the reactor 100 herein includes a supply inlet 1 configured to supply, into the reactor, a base composite material to be processed, i.e. herein a composite material including fibres and an organic matrix, and moreover an outlet 2 through which so-called “recycled” fibres are recovered, such a fibre including, for example, a fibre and less than 5% by weight, or less than 1% by weight of organic compound residue.

In this case, the reactor operates for example primarily with electricity.

For example, the reactor 100 includes an air injection inlet 101 and a superheated steam inlet 102.

In particular, the air injection inlet 101 is useful for a processing cycle including an oxidising post-processing step, for example according to an example of implementation of the present invention.

For example, the reactor 100 is a vacuum-controlled sealed electric furnace with forced convection opened by one single door leaf on one of the faces. It mainly consists of a reaction area with a useful volume of 3.375 m³. Heating of the reactor is ensured by six sets of electrical resistance with a total power of 118 kW.

In order to inject superheated steam, the device herein includes a steam superheater 103.

For example, the table hereinbelow presents characteristics of a superheater suitable in the context of the present invention:

TABLE
Characteristics of a superheater

| Parameters | Value | |
|---|---|---|
| Superheater electric power | 200-300 | kW |
| Superheater outlet | 160-600° | C. |
| temperature | | |
| Superheater outlet pressure | 100-200 | kPa |

In this case, the steam superheater operates for example primarily with electricity.

The steam superheater 103 then includes a superheated steam outlet 104 which is connected, for example via a duct, to the superheated steam inlet 102 of the reactor 100, as well as a saturated steam inlet 118 enabling supply thereof with steam.

For these purposes, the device includes a water processing unit 105.

In this case, the water processing unit operates for example primarily with electricity.

Hence, the water processing unit includes a running water supply inlet 106.

In the present example of implementation, the operation of the water processing takes place in a loop independent of the rest of the process. For example, the start-up of this unit operation is servo-controlled by the fill level of a storage unit 109. For example, an adjustable minimum level allows triggering the water processing members. For example, a production cycle can be started only if the water level is higher than a limit equal to the amount of water necessary for steam production over the total duration of a batch. Thus, the method is independent of a possible accidental water cut.

For example, the water processing operation takes place in two steps:
Softening the water with two exchange resin trays. The calcareous and potassium ions contained in the water of the network are exchanged with sodium ions in order to very greatly limit the possibility of formation of limestone during evaporation.
Reverse osmosis in order to reduce the concentration of ionic species that could generate a deposit.

Thus, the running water is processed in the water processing unit 105 which provides, on the one hand, an osmosed water and, on the other hand, an eluate. Consequently, the water processing unit 105 includes an osmosed water outlet 107 and an eluate outlet 108.

To store the osmosed water, the device includes the storage unit 109.

Such a storage unit has a capacity of a few cubic metres, for example between 5 m³ and 10 m³.

At the outlet of the storage unit 109, two pumps allow feeding a steam production and a system for cooling a thermal oxidiser 120.

Consequently, the storage unit 109 includes an osmosed water inlet 110, which is connected to the osmosed water outlet 107 of the water processing unit 105, and moreover, the storage unit 109 includes a first osmosed water outlet 111 configured to supply the cooling system of the thermal oxidiser 120, and a second osmosed water outlet 112 configured to supply a steam generator 113.

In order to generate a saturated steam, the device therefore includes the steam generator 113.

For example, the table hereinbelow presents characteristics of a steam generator suitable in the context of the present invention:

TABLE
Characteristics of a steam generator

| Parameters | Value | |
|---|---|---|
| Steam generator supply | Natural gas | |
| | 800-1,000 kW | |
| Steam maximum flow rate | 800-1,500 | kg/h |
| Steam generator outlet | 150-180° | C. |
| temperature | | |
| Steam generator outlet | 600-900 | kPa |
| pressure | | |
| Electric power | 5-15 | kW |

| | |
|---|---|
| Steam titre | 99-100% |

In this case, the steam generator operates for example with electricity and with natural gas.

In order to be supplied with osmosed water, the steam generator 113 includes an osmosed water inlet 114, which is therefore connected to the second osmosed water outlet 112.

The steam generator 113 also includes a combustion air inlet 115.

At the outlet, the steam generator includes a liquid effluent outlet 116.

It also includes a saturated steam outlet 117, configured to supply the steam superheater 103.

Hence, the saturated steam outlet 117 is connected, for example via a duct, to the saturated steam inlet 118 of the steam superheater 103.

For example, the device then uses steam production and superheating equipment involving, for example, a steam generator water quality of the pharmaceutical type. This water quality is defined by specifications of the equipment in order to avoid fouling and damage that could occur in this equipment.

Thanks to the use of a very pure water, such equipment allows generating steam very rapidly.

For example, the water of the steam generator has the following characteristics:

TABLE
Characteristics of the water of the steam generator

| Parameters | Value | |
|---|---|---|
| Acid conductivity (25° C.) | <2.5 | μS/cm |
| Na + K | <0.010 | mg/l |
| Fe | <0.020 | mg/l |
| Cu | <0.003 | mg/l |
| Si | <0.020 | mg/l |
| TOC | <0.2 | |
| O₂ | <2 | ppb |

| | |
|---|---|
| pH | >9.2 |

Moreover, the reactor 100 includes an outlet for steam and gaseous products 119.

Downstream, the device includes a thermal oxidiser 120.

In this case, the thermal oxidiser 120 operates for example with electricity and with natural gas.

The thermal oxidiser 120 includes an inlet for steam and gaseous products 121, which is connected, for example via a duct, to the steam and gaseous products outlet 119 of the reactor.

The thermal oxidiser 120 also includes a first osmosed water inlet 122, which is for example connected herein, for example via a duct, to the first osmosed water outlet 111 of the storage unit 109.

The thermal oxidiser 120 herein includes a second osmosed water inlet 123 configured to receive an osmosed water from a primary exchanger 127.

The thermal oxidiser 120 also includes air supply inlets 124, for example inlets for quenching air and for combustion air.

At the outlet, the thermal oxidiser 120 includes an outlet for gaseous effluents after processing 125.

Finally, the thermal oxidiser 120 includes an osmosed water outlet 126 configured to return an osmosed water to the primary exchanger 127.

For example, the thermal oxidiser 120 according to an embodiment of the invention is sized so as to have two combustion areas: a first one at 900-1,100° C. and a second one at 850-950° C.

For example, the table hereinbelow presents characteristics of an oxidiser suitable in the context of the present invention:

TABLE
Characteristics of an oxidiser

| Parameters | Value | |
|---|---|---|
| Natural gas burner power | 0.5-1.5 | MW |
| Thermolysis gaseous | 0.1-1.5 | MW |
| products burner power | | |
| Primary chamber rated | 900-1,100° | C. |
| temperature | | |
| Secondary chamber rated | 850-950° | C. |
| temperature | | |
| Lining | Fibres and | |
| | refractory bricks | |
| Combustion fumes speed | 10-20 | m/s |

Hence, the device further includes the primary exchanger 127 configured to circulate osmosed water in the thermal oxidiser 120.

In this case, the primary exchanger operates for example primarily with electricity.

For this purpose, the primary exchanger includes an osmosed water inlet 128 connected, for example via a duct, to the osmosed water outlet 126 of the thermal oxidiser 120, and an osmosed water outlet 129 connected, for example via a duct, to the second osmosed water inlet 123 of the thermal oxidiser 120. The primary exchanger 127 also includes herein a glycolated water inlet 133 and a glycolated water outlet 134.

Finally, the device includes a secondary exchanger 130 configured to circulate a glycolated water.

In this case, the secondary exchanger operates for example primarily with electricity. The secondary exchanger 130 herein includes a glycolated water inlet 131 which is connected, for example via a duct, to the glycolated water outlet 134 of the primary exchanger 127, and a glycolated water outlet 132 which is connected, for example via a duct, to the glycolated water inlet 133 of the primary exchanger 127.

In operation, upstream of all operations on the reactor 100, the method includes a step of operating the thermal oxidiser 120 and holding it in a steady state.

Thus, operations of increasing and decreasing the temperature of the reactor 100 have a low emission level, and a risk of generating discharge levels higher than in the steady state of the reactor is thus very limited and even avoided.

Thus, the thermal oxidiser 120 operating in a steady state, the method includes a step of loading the reactor 100 with the base composite material to be processed and a step of heating the reactor, first under air, then under superheated steam up to a processing plateau temperature.

The temperature plateau is maintained the time necessary to eliminate a maximum of the organic matrix on the fibres of the base composite material.

In this manner, during the phase of decreasing the temperature of the reactor by injection of saturated steam, a minimum organic compound, an even not at all, is emitted from the reactor towards the thermal oxidiser 120.

The operation of the oxidiser is still maintained during this phase in order to best avoid a condensation of steam in the oxidiser.

The operation of preparing and loading the base composite material is done in batches. For example, parts made of composite materials to be recycled have been classified beforehand by type of fibres and organic compound in order to have one single type of material to be processed by batch. Next, the parts may be loaded onto a support which could be transported by a lift truck and/or forklift.

This support is configured to guarantee an optimum distribution of the temperature and of steam in the entire reactor. It also guarantees the collection of recycled fibres to ensure a determined mechanical cohesion at the end of a steam-thermolysis step.

For example, the support is a metal cube with a system for cooperation with a forklift (or a trolley); it includes a shelf system (i.e. a rack system) to arrange the materials and have an adequate distribution of the temperature.

In order to control the method accurately and to control the quality of the degradation of the organic compound, the composite material to be processed is, for example, weighed using weights before insertion into the reactor, as well as at the outlet of the processing.

Afterwards, the support is introduced into the reactor (cleaned beforehand where necessary) with the composite materials to be processed.

For example, each batch is composed of at most 2,000 kg of composite material.

### 1. Steam Generation

The steam essential to the steam-thermolysis reaction is produced herein by the steam generator 113 and the superheater 103. The steam has two functions in the process described herein:
A function of inerting the reaction medium in order to limit the oxygen concentration and to avoid the apparition of an oxidation reaction in the reactor.
A catalyst function by lowering the thermal cracking temperature of the organic compound.

First, the osmosed water is pumped into the storage unit 109 in which the oxygen content and the pH are lowered.

The steam coming out of the steam generator is conditioned by a separator in order to have a steam titre higher than 99%.

Afterwards, a dry steam thus created is expanded to about 100 kPa and then superheated by the superheater 103 in order to achieve the desired conditions for use by the method.

The pressure rise of the steam equipment being very rapid (3-4 minutes for the steam generator 113), it is performed when the temperature of the reactor is higher than 160° C. for example, in order to avoid any condensation phenomenon in the gaseous effluent processing chain.

The steam generator 113 operates at the same speed over the entire processing batch. Hence, a steam mass flow rate is a fixed parameter of the method. The temperature of the steam is modulated using the superheater 103 during the phases of raising and lowering the temperature of the plant.

The saturation steam is generated with the steam generator, which is for example an instantaneous vaporisation steam generator with a power of 800 to 1,000 kW operating with natural gas, and which is configured to produce a first portion of superheating. Such a technology also allows a very rapid pressurisation and is compatible with a batch process. The steam titre at the steam generator outlet is higher than 99% (namely comprised between 99% and 100%), which corresponds to a pharmaceutical or food standard.

When coming out of the steam generator, the steam passes into the superheater 103 which handles the completion of superheating, so that the steam reaches, for example, 500° C. at 101,325 Pa (pascal).

### 2. Steam-Thermolysis Reaction

In the reactor 100, the action of the temperature in an atmosphere made inert by superheated steam enables thermal cracking of the organic matrix in the form of a gaseous product.

It is provided for a continuous oxygen measurement in the reactor 100 throughout the process, as well as an emergency injection of nitrogen if the oxygen concentration becomes at least equal to 8%. The critical points of this equipment for the quality of the product are the homogeneity of the temperature and of the steam flow. The composites being loaded onto a loading support, the latter is configured so as not to generate dry or cold areas in the reactor.

A controllable stirring fan allows reaching, at the plateau temperature, a homogenisation at more or less 1.5° C. The superheated steam is continuously injected into the reactor in order to guarantee inerting and produce the atmosphere necessary for the steam-thermolysis. This steam and the thermolysis gaseous products are continuously extracted from the reactor thanks to a hot gas extractor with a remote belt drive and controlled by the depression value of the reactor.

The steam is injected when the temperature of the reactor is higher than the condensation temperature at 700 kPa (160° C.). Afterwards, the rise in temperature continues according to the plateau temperatures provided for, comprised between 30° and 600° C. For example, the total duration of these temperature plateaus is comprised between 2 hours and 4 hours. For example, the ratio of the injected steam flow rate to the mass of the composite is comprised between 0.5 and 1.5.

After the temperature plateau, heating of the reactor is stopped, the reactor is cooled by injection of saturated steam and then of ambient air and of nitrogen (where necessary). When the temperature reaches 140° C., the door of the reactor can be opened. Afterwards, cooling continues down to 50-60° C., at which temperature the loading support can be removed from the reactor.

### 3. Oxidising Post-Processing

In addition to a thermolysis or steam-thermolysis processing, the processing method according to the invention allows implementing a post-processing. This complementary processing is so-called “oxidising post-processing”.

Indeed, some wastes are composed in part of organic compounds which cannot be totally eliminated solely by the completion of a thermolysis or steam-thermolysis and therefore requires a second processing step: the oxidising post-processing step. The oxidising post-processing step essentially consists in injecting a controlled amount of oxygen inside the reactor which is maintained at a defined and controlled temperature in order to oxidise the organic compounds that are still present on a fibre to transform them into CO and into CO₂.

It allows removing a portion of the organic compound which is not degraded, or not degradable, or not entirely degradable, by thermolysis or steam-thermolysis, irrespective of the operating conditions, as well as, where appropriate, other organic compounds (such as tars, chars or other residues) which could have been obtained by transformation of the organic compound of the composite material during the prior thermolysis or steam-thermolysis step. For this purpose, the oxygen injection is carried out by injecting air inside the reaction medium, for example by means of a dedicated valve.

This injection may take place:
After a complete thermolysis or steam-thermolysis reaction (everything that could have been degraded in thermolysis or steam-thermolysis has already been degraded);
With or without maintaining a steam injection in parallel (for example an air injection which therefore includes O₂);
Preferably between 30° and 600° C.;
For a time period which may generally be comprised between 20 min and 6 h.

The selection of the different modalities depends on the processed material and on the desired residual organic compound content. Preliminary analyses in laboratories allow, for example, estimating the amounts of materials to be degraded and therefore the appropriate processing (duration and flow rate of O₂ for example).

For example, the end of the oxidation reaction is measured by stabilisation of the O₂ level at the reactor outlet, for example around 20-21%.

Once a temperature plateau has been completed, for example at a temperature comprised between 400° C. and 600° C., and therefore a complete thermolysis/steam-thermolysis reaction, are described hereinafter three examples of implementation according to the invention:

According to a first example of implementation, the method includes a step of reducing the temperature in the reactor and then a step of maintaining this temperature before finally cutting off the injection of steam and introducing only air into the reaction medium, for example at a controlled flow rate. To do so, for example, in a first step, the superheater is stopped in order to inject saturated steam (for example at 100° C.) into the reactor and proceed with cooling. Once the temperature of the reaction medium is reached, the injection of steam is stopped, the temperature is maintained, for example by the action of heating resistors of the reactor, and ambient air is introduced into the reactor. For example, a regulation of the air injection flow rate is done on the O₂ content at the outlet of the reactor. Once this rate tends towards 20-21%, the oxidising post-processing step is complete and, for example, saturated steam is injected again in order to proceed with cooling of the product.

According to a second example of implementation, the reaction medium is not cooled because some compounds require the oxidising post-processing step to take place at 500° C. Nevertheless, unlike the first example, an injection of superheated steam at about 500° C. is kept in order to more rapidly renew the reaction volume and therefore maintain a stable temperature. For example, ambient air is injected into the reaction medium at 500° C. no longer by regulating an O₂ content at the outlet (for example oxygen is diluted in the vapor) but by injecting a constant air flow for a defined plateau time period. Indeed, the mass of organic compound to be processed by oxidising post-processing allows defining the mass of O₂ to be injected and therefore determining which air flow to introduce for which duration. Like for the first example of implementation, once the reaction is complete, the injection of air can be stopped, as is heating of the steam, in order to proceed with cooling of the product thanks to the saturated steam.

According to a third example of implementation, the first and second examples are cumulated, i.e. firstly, the method includes a step of cooling then afterwards a step of slow heating the reaction medium, during the oxidising post-processing step, for example, in order to control an air flow rate but also the oxidising post-processing reaction temperature. Nevertheless, this example of implementation is longer in time and requires more energy.

In general, these examples of implementation are implemented directly after the thermolysis or steam-thermolysis reaction (before the temperature decrease and opening of the reactor). Nevertheless, they may also be done on an independent cycle (after complete cooling and a new temperature rise). Nonetheless, this then induces an energy additional cost (it is necessary to raise the temperature at the beginning of the second cycle).

### 4. Processing of the Gaseous Products

The gaseous products derived from the steam-thermolysis are processed by complete decomposition using a thermal oxidation. This equipment is composed of a low NOx burner, two combustion chambers as well as an SNCR (selective non-catalytic reduction) processing of NOx with urea spraying.

The thermolysis gases derived from the thermolysis reaction are primarily composed of organic species (C, H, O, N), they are processed by thermal oxidation (reaction with oxygen under temperature) to form carbon dioxide (CO₂), water (H₂O) and nitrogen oxides (NOx). In order to comply with the nitrogen oxide emissions limitations, an example of a combination of waste control technologies has been put in place with the following elements:
A LowNOx burner which generates little NOx during the oxidation of the organic species.
A double oxidation chamber configured to enable a complete oxidation of the organic compounds without oxidising the nitrogen.
A reduction of the residual NOx by “non-catalytic reduction” with a spraying of urea in the gas stream under temperature. The urea flow rate will be oversized compared to the amount of NOx to be processed, thereby enabling a maximum reduction.

The first oxidation chamber is controlled in sub-stoichiometry at very high temperature and in order to substantially limit the apparition of nitrogen oxide, this equipment is provided with a double envelope. This morphology allows cooling the metal structure of the primary oxidation chamber. A rail for spraying 20 to 50 m³/h of osmosed water is installed in order to maintain the temperature of the structure within the limits acceptable for the material. The cooling water is collected in the bottom of the double envelope, then pumped towards a plate exchanger, the primary exchanger 127, to be cooled and re-injected into the oxidiser 120 for a new cooling cycle.

A counter-current flow of glycolated water, for example at a flow rate comprised between 30 m³/h and 60 m³/h, also passes through the plate exchanger 127 to finally discharge the excess calories thanks to a closed-circuit air cooler located outside.

The gaseous release in the atmosphere is cooled by injection of fresh air (for example between 5,000 and 25,000 Nm³/h) at the outlet of the thermal oxidiser 120 in order to limit the chimney temperature. For example, the temperature is comprised between 30° and 400° C. for a steel chimney, for example with a diameter in the range of 900 mm to 1,500 mm, which allows, for example, limiting the ejection speed and/or sound pollution.

The processing of the gaseous effluents consists of a bare-flame oxidation of all of the organic species in presence. The guidelines regarding this type of processing recommend a passage of the organic compounds at a higher temperature at 850° C. at least for 2 seconds.

For example, the thermal oxidiser 120 according to an embodiment of the invention is sized so as to have two combustion areas: a first one at 900-1,100° C. and a second one at 850-950° C., as described before.

### 5. Unloading, Quality Control and Conditioning

At the end of the cooling of the reactor at a temperature lower 50-60° C., the latter is opened and unloaded using a forklift for example. The loading support with fibres is subsequently weighed with the same balance as during loading in order to control the rate of degradation of the organic compound of the composite. Afterwards, the fibres are removed from the loading carriage and arranged in a transfer area.

A sample of the obtained recycled fibres is made in order to perform a control of the quality of the thermolysis reaction (absence of residual organic compound on the recycled fibres). If this prior control proves positive, then mechanical controls of the quality of the rCFs are performed. Afterwards, the recycled fibres undergo the following operations:
Sorting: at the outlet of the steam-thermolysis reactor, the carbon fibres are separated from the other waste (bolts, etc.);
Conditioning and storage: the sorted rCFs are conditioned and then stored in cardboard, bags, IBC or big bags;
Shipping: on order, the carbon fibre is packaged in cardboard, bags, IBC or big bags depending on the needs of the customers.

1-20. (canceled)

21. A method for processing in a reactor a composite material including reinforcing fibers and an organic compound at least partially coating one of the fibers, comprising:
heating a reactor at a first temperature comprised between 300° C. and 600° C.;
injecting oxygen into the reactor to produce an oxygen content comprised between 2% and 15% of a reaction volume of the reactor,
injecting steam into the reactor, the steam being superheated at a temperature comprised between 300° C. and 600° C., and
oxidizing the organic compound into at least one of carbon monoxide and carbon dioxide.

22. The method according to claim 21, wherein the oxygen is injected into the reactor at an ambient temperature comprised between 15° C. and 50° C.

23. The method according to claim 21, wherein the oxygen is injected into the reactor after being heated at a temperature comprised between 50° C. and 600° C.

24. The method according to claim 21, wherein the oxygen is injected into the reactor for a time period comprised between 10 minutes and 6 hours.

25. The method according to claim 21, further comprising, prior to injecting oxygen into the reactor:
reducing temperature in the reactor from the first temperature to a second temperature, the second temperature being comprised between 300° C. and 500° C.; and
maintaining the second temperature for a time period comprised between 10 min and 6 hours.

26. The method according to claim 25, further comprising reducing steam injection into the reactor.

27. The method according to claim 25, wherein an injection flow rate during said injecting step is regulated according to an oxygen content at an outlet of the reactor.

28. The method according to claim 25, wherein said reducing temperature in the reactor comprises reducing temperature of superheated steam injected into the reactor.

29. The method according to claim 21, further comprising simultaneously or alternately assaying steam and oxygen flow rates to maintain temperature and oxygen content of the reaction medium, respectively between 300° C. and 600° C. and 2% to 15%.

30. The method according to claim 21, further comprising measuring an amount of oxygen at an outlet of the reactor; and, if an oxygen content is stable:
stopping oxygen injection; and/or
stopping heating of the steam; and/or
cooling the reactor by injecting saturated steam.

31. The method according to claim 21, further comprising, prior to said heating step, performing thermolysis or steam-thermolysis of the composite material.

32. A processing device configured to implement the method according to claim 21, the device including a reactor and a steam superheater upstream of the reactor, the steam superheater being configured to heat steam to a temperature comprised between 300° C. and 600° C. for injection into the reactor.

33. The device according to claim 32, further comprising at least one sensor configured to control said method, and a controller configured to automatically regulate said method according to data transmitted by the at least one sensor.

34. The device according to claim 32, further comprising a water processor configured to process running water and provide osmosed water.

35. The device according to claim 32, further comprising a storage tank configured to store osmosed water.

36. The device according to claim 34, further comprising a steam generator configured to superheat the osmosed water and provide saturated steam for the steam superheater.

37. The device according to claim 32, further comprising a thermal oxidizer configured to process steam and gaseous products originating from the reactor.

38. The device according to claim 37, further comprising a primary exchanger configured to circulate osmosed water in the thermal oxidizer.

39. The device according to claim 32, further comprising a secondary exchanger configured to circulate an air cooling medium.

40. A recycled fiber obtained by the method according to claim 21, the recycled fiber including a fiber and between 0% and 5% by weight of organic compound residue.
